(19) United States
(12) Patent Application Publication
(10) Pub. No.: US 2026/0077860 A1
(43) Pub. Date: Mar. 19, 2026

(54) AIRCRAFT GALLEY WITH SMART COUNTERTOP

(71) Applicant: Airbus Operations GmbH, HAMBURG (DE)

(72) Inventors: Matthias REISS, HAMBURG (DE); Rafael MORTENSEN ERNITS, BREMEN (DE)

(21) Appl. No.: 19/327,361

(22) Filed: Sep. 12, 2025

(30) Foreign Application Priority Data
Sep. 13, 2024 (DE) 102024126404.7

(51) Int. Cl. B64D 11/04; B64D 11/00; G06F 3/14

(52) U.S. Cl. CPC B64D 11/04; B64D 11/0015; G06F 3/14

(57) ABSTRACT

An aircraft galley having a smart countertop and a controller. The countertop comprises a base plate and a component layer arranged thereon which has at least one electrical and/or electronic component, in particular at least one display. The controller is set up to show on the display a work-supporting message describing at least part of an activity currently to be carried out on the countertop. Alos an aircraft with such a galley.

### CROSS-REFERENCE TO RELATED APPLICATIONS

This application claims priority to German Patent Application No. 10 2024 126 404.7, filed on Sep. 13, 2025, the entire disclosures of which are incorporated herein by way of reference.

### FIELD OF THE INVENTION

The present disclosure relates in general to an aircraft galley having a smart countertop. In particular, the present disclosure relates to an aircraft galley having a countertop comprising at least one display and a controller capable of displaying a work-supporting message on the display. Further disclosed is an aircraft having such an aircraft galley.

### BACKGROUND OF THE INVENTION

Galleys are standardly used in aircraft to prepare food and drinks for passengers. Furthermore, an aircraft galley is often also used as a place to hold papers on which, for example, special food requests from passengers and the like are noted.

However, there is still a need to improve the work of aircraft personnel, in particular in aircraft galleys.

### SUMMARY OF THE INVENTION

This task may be achieved by the present invention as described in one or more embodiments herein.

According to a first aspect, for a better understanding of the present disclosure, an aircraft galley comprises a countertop and a controller, wherein the countertop comprises a base plate and a component layer arranged thereon comprising at least one electrical and/or electronic component. The countertop is thus expanded by the functionality of the electrical and/or electronic component. Instead of a simple work surface, the aircraft galley disclosed here offers additional functions that make work easier for the flight crew.

Thus, the component layer comprises at least one display, while the controller is set up to show on the display a work-supporting message describing at least part of an activity currently to be carried out on the countertop. The “smart” countertop can therefore support the flight crew in determining when to perform which activity. Although flight crews are extensively trained, the various activities of the crew and the demands of passengers are increasing, which means that the complexity of the work to be done by the flight crew is constantly increasing. By displaying a work-supporting message, the flight crew's work is made easier, so that it can be done more efficiently and also faster, thus improving the service.

As an example only, the smart countertop can display whether a particular passenger, or which passengers, have ordered special meals. Food is also often prepared individually for passengers in business class, and here the display on the countertop can be used to show the meal desired by the passenger currently being served. In particular, if the activity to be carried out comprises multiple work steps (for example arranging a general appetizer, specific main course, desired drink, etc. on a tray), the controller can show each individual step on the display, thus assisting the flight crew member. Each individual step can be displayed simultaneously or in the order in which it is to be processed. Of course, activities other than meal preparation can also be displayed, such as darkening the cabin at a certain stage of the flight, crew break times, information for other members of the flight crew, one of the pilots leaving the cockpit, a message from a pilot to the flight crew, etc.

In one variant implementation, the component layer can further comprise at least one input element, and/or an illuminant, and/or a plurality of visually and/or haptically changeable deposit surfaces, and/or at least one sensor that is set up to detect the presence of an object on an associated region of the countertop and to generate a corresponding signal that can be processed by the controller, and/or at least one receiver for reading out a near-field communication chip (NFC chip), and/or a flexible conductor track. The component layer is therefore not limited to a display, but can be used in a variety of ways to interact with the flight crew.

For example, the illuminant can be used to indicate a passenger service request, while the display shows the seat number. On the other hand, the flight crew can use the at least one input element to, for example, jump to the next step in the activity to be carried out, which next step is then shown on the display. The same can also be done using the at least one sensor if the sensor detects the presence of an object on the countertop indicating that the work step currently being carried out has been completed.

Another example is a temperature sensor that can be used to measure the temperature of a placed object. If this object is hot, this can be indicated via the display and/or the illuminant and/or the visually and/or haptically changeable deposit surface, so that the flight crew are made aware of the hot object. This can also be done without a temperature sensor if a hot object is to be or has been placed at a certain location (i.e. a deposit surface) on the countertop during a performed work step.

In a variant implementation, the controller can also be set up to receive a signal from the at least one input element and to control a further component of the component layer on the basis of the received signal. This can be a jump to the next work step to be carried out, which is accordingly shown to the flight crew on the display or in some other form.

Alternatively or in addition, the controller can be set up to display, using the illuminant, the work-supporting message in a sequence of steps of the activity to be carried out. As an example only, the illuminant can assume different colors, or there can be a plurality of illuminants that are illuminated one after the other by the controller, with each illuminant corresponding to a specific work step in the sequence of steps.

Alternatively or in addition, the controller can also be set up to visually and/or haptically identify at least one of the plurality of deposit surfaces associated with the current work step (and, correspondingly, with the work-supporting message). For example, the deposit surfaces can be set up to change their color, to mark by color a border of the deposit surface, to change a surface structure of the entire deposit surface or along its border, or the like. In this way the flight crew can for example be shown where certain dishes need to be placed in order to simplify the workflow and to prepare a complete meal quickly and safely.

Furthermore, alternatively or in addition, the controller can be set up to process the signal from the at least one sensor and to control a further component of the component layer accordingly, and/or to select the next work-supporting message relating to the next work step of the activity to be performed and to display it via the components of the component layer. For example, the next message can be shown on the display or can be output using at least one of the other elements of the component layer. The at least one sensor can be a pressure sensor, temperature sensor, presence sensor, proximity sensor, etc. For example, the controller can use a pressure sensor, presence sensor or proximity sensor to detect that a plate, bowl, glass, etc., has been placed on the countertop (e.g. on a deposit surface provided therefor of the multiple deposit surfaces). The next deposit surface can then be identified visually and/or haptically, and/or the next message or work step of the activity can be shown on the display, and/or the illuminant can be switched on accordingly to indicate the next step.

Alternatively or additionally, the controller can also be set up to receive a signal from the NFC chip and to evaluate the information contained in the signal. For example, plates, glasses or other objects can be provided with an NFC chip. Each food storage container can also be equipped with an NFC chip so that the controller can not only detect the presence of the corresponding container or object, but can also evaluate the type of container or object. The controller can also obtain information about the contents of the container or object from the NFC chip. As an example only, information can be stored on the NFC chip when the corresponding container is filled, for example in a large kitchen at the airport which prepares a large number of meals and provides them in the corresponding containers and delivers them to the aircraft.

In one variant implementation, at least one portion of the countertop can comprise a textile. The textile surface offers not only a better look but also the possibility of integrating additional functionality. For example, the textile can comprise a smart portion. A smart portion can comprise one or more fibers that can change color, emit light, or detect touch. This means that the smart portion of the textile can function as a display, illuminant, and input element. The smart textile can also be regarded here as part of the component layer, as it is linked to the controller and can exchange signals with it.

In one variant implementation, a protective surface can be applied to at least one portion of the component layer. This protective surface can be flexible and/or replaceable, for example. In this way, the countertop can be kept clean more easily, and/or can be easily cleaned for the next flight.

In a variant implementation, the aircraft galley can in addition comprise at least one communication interface that is set up to exchange data with an electronic device by a cable connection or wirelessly. The electronic device can be an electronic device operated by a member of the flight crew, such as a tablet or other mobile device.

In a variant implementation, the controller can preferably be set up to send the work-supporting message and/or information about the current work step to the electronic device and/or to receive a user input from the electronic device. The electronic device can therefore facilitate the work of the flight crew, together with the smart countertop. For example, the user input can be an input associated with the work step currently being performed, in which the flight crew member for example confirms the work step in order to move to the next work step. Conversely, the flight crew member can also make a user input on the smart countertop, with a/the result (also) being displayed on the electronic device.

In one variant implementation, the component layer can further comprise a scale, and/or a heating element, and/or a cooling element. This means that certain activities, including heating or cooling objects, food, drinks, etc., can be done more easily and faster using the smart countertop. As an example only, the flight crew member can remove a dish from a cooling unit, place it on a deposit surface provided for this purpose, and the smart countertop can warm or heat the dish via the heating element while the flight crew member performs the next work steps. The scale can be used for example to portion a specific meal or part of a meal, to mix a drink, and the like.

In a variant implementation, the countertop can be movable between a working position in which the countertop is arranged horizontally and a display position in which the countertop is arranged vertically. Thus, in the horizontal configuration the countertop can be used like a regular countertop (but with the smart additions disclosed here). In the display position, in contrast, the display integrated in the countertop can continue to be used.

As an example only, flight attendant seats are usually located near a galley. If the flight crew member is sitting in such a flight attendant seat, the display in the work surface is not visible and/or the information displayed on it cannot be viewed. The display can still be used by moving the countertop to the display position. Also as an example only, the display can show a video image of the passenger cabin so that the flight crew member can observe the passengers even when the crew member is sitting in the flight attendant seat. As this observation of passengers is one of the requirements for flight attendant seats, the use of the countertop in the display position means that the flight attendant seat can also be installed in locations other than previously usual ones (for example, in a position from which the passenger cabin is not directly visible). The countertop display can thus be used as an “electronic mirror.”

Of course, other information can also be shown on the display, such as messages from the cockpit, cabin status information, etc.

In one variant implementation, the countertop can have a surface coating or cover that is designed to change its shape. This change in shape can take on certain patterns, for example to identify a deposit surface to be used in the work-supporting step. The change in shape can also be used to display information; in other words, the surface becomes a display. The change in shape can be achieved, for example, by electrically controlled expansion of the material and/or by inflating corresponding channels or channel portions in the material.

In one variant implementation, the countertop can also have a surface coating or a cover that includes integrated input elements. As an example only, the surface coating or cover can include an air bubble or channel. Pressing on the coating or cover changes the air pressure in the bladder or channel, which can be registered by a corresponding sensor.

According to a second aspect for a better understanding of the present disclosure, an aircraft comprises at least one aircraft galley according to the first aspect or one or more variant implementations thereof.

The present disclosure is not limited to the aspects and variant implementations in their stated order. In particular, the description of the aspects and variant implementations is not to be understood as a specific grouping of features. Rather, the present disclosure also covers combinations of the described variant implementations with each other, as well as combinations of the second aspect with variant implementations of the first aspect.

### BRIEF DESCRIPTION OF THE DRAWINGS

In the following, the present disclosure is described with reference to exemplary variant implementations shown in the figures, wherein:

FIG. 1 schematically shows a plan view of a countertop;

FIG. 2 schematically shows a section and a plan view of a countertop;

FIG. 3 schematically shows a galley; and

FIG. 4 schematically shows an aircraft having a galley.

### DETAILED DESCRIPTION OF THE PREFERRED EMBODIMENTS

In the following description, for the purpose of explanation and not limitation, certain details are set forth to provide a general understanding of the present disclosure. The person skilled in the art will understand that the present disclosure can also be implemented in other variants that differ from those shown in the figures.

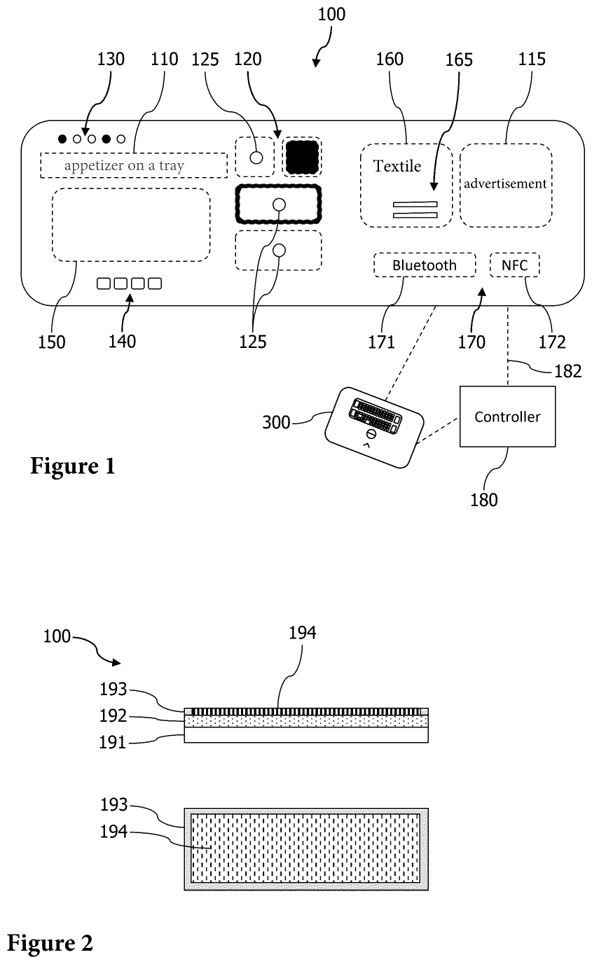

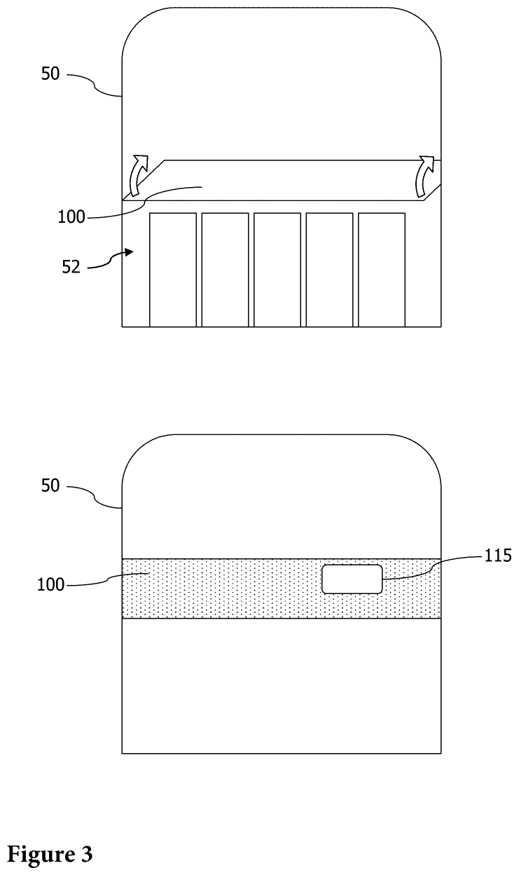

FIG. 1 schematically shows a plan view of a countertop 100. The countertop 100 can be part of a galley 50 (FIG. 3). As an example only, the countertop 100 can be situated above trolley storage spaces 52. In the galley 50, a controller 180 is also provided which is coupled to the countertop 100.

With reference to FIG. 2, the countertop 100 has a base plate 191 and a component layer 192 arranged thereon. The component layer 192 comprises at least one electrical and/or electronic component. A protective surface 194 can be applied to the component layer 192. This protective surface 194 can be flexible, replaceable, and/or transparent, for example. The protective surface 194 can be attached by means of a frame 193, and the frame 193 with the surface 194 can be removable and thus replaceable. Of course, a different structure of the countertop 100 can be provided.

The component layer 192 comprises at least one display 110, 115 which is also coupled to the controller 180 and can be controlled by it. The display 110 shows a work-supporting message that describes at least part of an activity that is currently to be carried out on the countertop. For this purpose, the controller 180 stores information about activities to be carried out and can provide this information to a user, such as a flight crew member, via the display 110 (and/or display 115). As an example, FIG. 1 shows that an “appetizer on a tray” is to be served. Of course, any information can be provided via the display 110, 115, including text, images, colors, etc. This provides instructions for the activities to be carried out, making the flight crew's work easier.

It can be the case that the display 110, 115 functions only as a display. Alternatively, a touch-sensitive display (so-called touchscreen) can also be used so that the display 110, 115 can also be used as an input element.

The smart countertop 100 can also comprise other elements, such as at least one input element 140, 165. These may be, for example, switches or buttons 140 that can be operated by pressing or touching. The input elements 165 are arranged, as an example, in a region 160 of the countertop 100 made of a textile. The countertop 100 can be covered with a textile in this region. Of course, the textile region 160 can also be part of the component layer 192. The input elements 165 are, for example, air-filled regions or channels whose internal pressure can be changed by external contact. Using a pressure sensor (not shown), the change in pressure can be measured and passed on to the controller 180, making these elements input elements of the component layer 192.

The textile region 160 can itself be used as an information output. For example, the textile region 160 can comprise fibers that can change their color, change their temperature, or have illuminants such as micro-LEDs. This means that the textile region 160 can be used flexibly, on the one hand to display information (for example in the form of text, colored regions or the like) and on the other hand to change the temperature of objects placed on it. Similarly, the fibers can also include pressure and/or temperature sensors to determine whether an object has been placed in the region 160 and/or to measure the temperature of the placed object. The measured temperature can also be used, for example, to display an indication of a cold or hot object.

The component layer 192 can in addition comprise an illuminant 130. As an example, FIG. 1 shows five lights, two of which are shown as activated (in the form of a black dot). The illuminant 130 can be a single light-emitting device, or (as shown) can be implemented in the form of a plurality of illuminants. In any case, the illuminant 130 can be used to provide the flight crew with information. As an example only, a combination of activated illuminants 130 can represent a work step currently to be carried out in a sequence of work steps. Alternatively or in addition, other instructions can be given to the flight crew, such as a service call from a passenger or the like.

Furthermore, for example, written designations (not shown) can be indicated next to the individual illuminants 130 on the countertop 100 (for example on the surface 194 or on the frame 193). Also as an example only, a display 110 provided next to the illuminants 130 can also indicate a designation of each of the individual illuminants 130.

The component layer 192 can further comprise a plurality of visually and/or haptically changeable deposit surfaces 120. These deposit surfaces 120 can be made visually or haptically recognizable to the user. A visual change of the deposit surfaces 120 can occur via a change of color of a material of the component layer 192 and/or of the surface 194 which is triggered electrically and/or thermally. Alternatively, in the component layer 192 a light-emitting material can be present that lights the deposit surface 120. It is possible for the entirety of the deposit surfaces 120 to change color or be illuminated (shown as an example by deposit surfaces 120 completely filled in black). Alternatively, it can be that only a border of the deposit surfaces 120 is changed in color or lights up (correspondingly shown in FIG. 1).

Alternatively, the shape and/or surface of a material in the region of each of the deposit surfaces 120 can also change, making a haptic change possible. This can be achieved by using an appropriate material that reacts to electrical and/or thermal changes by changing its shape. In addition, it is also possible to use a textile in the region of the deposit surfaces 120, which textile can be inflated via channels or channel portions in certain regions. This allows one or more deposit surfaces 120 as a whole, a portion thereof or, for example, a border thereof to be inflated in order to highlight the deposit surfaces 120 haptically and also visually. The change of the deposit surface 120 in each case can be done using the controller 180.

As an example only, a transparent tray can be placed on the countertop 100 so that the change in the deposit surfaces 120 can still be seen. This allows the arrangement of certain dishes and/or drinks on the tray to be accordingly displayed to the flight crew. For example, one deposit surface 120 can always be highlighted visually and/or haptically step by step (with or without a tray placed on it).

The controller 180 can also be set up to receive a signal from the at least one input element 140, 165 and to control a further component of the component layer 192 on the basis of the received signal. Furthermore, the controller 180 can be set up to indicate to the flight crew a current work step in a sequence of steps representing the activity to be carried out by the flight crew, using the illuminant 130, the display 110, 115 and/or at least one of the plurality of deposit surfaces 120, thus guiding the flight crew.

The component layer 192 can in addition comprise at least one sensor 125 which is set up to detect the presence of an object on an associated region of the countertop 100, and/or to detect the temperature of the object, and to generate a corresponding signal which can be processed by the controller 180. The controller 180 can control at least one further component of the component layer 192 on the basis of the signal. For example, the next work-supporting message (or the next work step in the sequence of steps) can be selected and output via at least one of the components of the component layer 192.

The at least one sensor 125 can be a pressure sensor, presence sensor, proximity sensor, temperature sensor, or the like.

The aircraft galley 50 can in addition comprise at least one communication interface 170 that is set up to exchange data with an electronic device by a cable connection or wirelessly. As an example only, FIG. 1 shows a tablet (mobile electronic device with touchscreen) as an example of a mobile electronic device that can, for example, communicate with the countertop 100 and/or with the controller 180 via a Bluetooth interface 171. The tablet can be used both as an input and output device together with the smart countertop 100.

Another communication means 170 is the near-field communication receiver 172 (NFC receiver) shown in FIG. 1. For example, this receiver can be set up to generate and receive a signal from an NFC chip and forward it to the controller 180. The controller 180 can correspondingly control at least one component of the component layer 192 based on the information obtained from the NFC receiver 172. Of course, the NFC receiver 172 can also directly address and control a component of the component layer 192.

As an example only, a particular container (plate, glass, etc.) can be provided with an NFC chip so that its presence on the countertop 100 can be detected. Alternatively or additionally, the NFC chip can also store information about the contents of the container, which can be processed accordingly (for example, whether the container contains a particular meal (vegetarian, vegan, halal, etc.)).

Furthermore, the countertop 100, in particular the component layer 192, can comprise a scale 150. This allows particular products to be portioned, meals to be assembled, drinks to be mixed, and the like.

Finally, the countertop 100, in particular the component layer 192, can also comprise a cooling element or heating element. These two elements are not explicitly shown in the figures, but can be implemented at any location of the component layer 192, such as in the region 150, the textile region 160, and/or one or more of the deposit surfaces 120. This allows objects placed there to be cooled or warmed (heated up).

FIG. 3 also shows that the countertop 100 can be moved between a working position (upper illustration in FIG. 3) and a display position (lower illustration in FIG. 3). Thus, in the working position the countertop 100 is configured substantially horizontally, and serves as a smart work surface. In the display position, in contrast, the countertop 100 is configured substantially vertically. The display 110, 115 can also be viewed by flight crew members who are further away from the countertop or, in particular, who are not standing in front of the countertop 100. For example, the display 115 in FIG. 3 can also be seen from a flight attendant seat, and information displayed on it can be easily recognized.

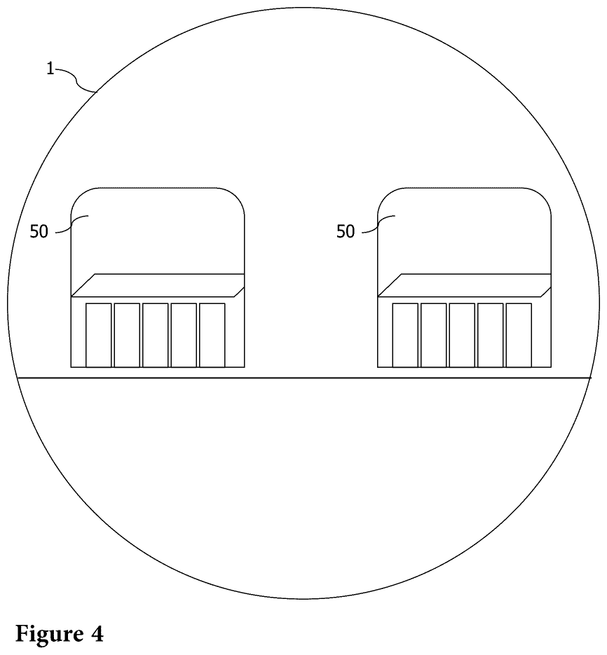

Finally, FIG. 4 shows an aircraft 1 comprising an aircraft galley 50. In particular, the aircraft galley 50 can be the aircraft galley 50 of FIG. 3, having a countertop 100 as shown in FIGS. 1 and 2.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The advantages of the technology described herein are made apparent by the foregoing description. Furthermore, it will be understood that the present disclosure also includes combinations of the features disclosed herein which have not been explicitly described. In particular, some of the features shown in the figures can also be omitted, or can be multiply present.

1. An aircraft galley comprising:
a countertop; and
a controller,
wherein the countertop comprises a base plate, and a component layer arranged thereon which has at least one electrical component, at least one electronic component, or at least one both, and wherein the component layer comprises at least one display, and
wherein the controller is configured to show, on the display, a work-supporting message that describes at least a part of an activity to be carried out on the countertop.

2. The aircraft galley according to claim 1, wherein the component layer further comprises:
at least one input element; or
an illuminant; or
a plurality of visually changeable deposit surfaces; or
a plurality of haptically changeable deposit surfaces; or
at least one sensor configured to detect a presence of an object on an associated region of the countertop and to generate a corresponding signal to be processed by the controller; or
at least one near-field communication receiver; or
at least one flexible conductor track; or
any combination of the foregoing.

3. The aircraft galley according to claim 2, wherein the controller is further configured to:
receive a signal from the at least one input element and to control a further component of the component layer based on the signal received; or
display, using the illuminant, a current work step in a sequence of steps comprising the activity to be carried out; or
identify, visually, at least one of the plurality of visually changeable deposit surfaces associated with a current work step;
identify, haptically, at least one of the plurality of haptically changeable deposit surfaces associated with a current work step;
process the corresponding signal from the at least one sensor and control a further component of the component layer, or select a next work-supporting message and display the next work-supporting message, or both; or,
any combination of the foregoing.

4. The aircraft galley according to claim 1, wherein at least a portion of the countertop comprises a textile; or
wherein a protective surface is applied to at least one portion of the component layer; or
both.

5. The aircraft galley according to claim 1, wherein at least a portion of the countertop comprises a textile with a smart portion.

6. The aircraft galley according to claim 1, wherein a protective surface is applied to at least one portion of the component layer, the protective surface being flexible, or replaceable, or both.

7. The aircraft galley according to claim 1, further comprising:
at least one communication interface configured to exchange data with an electronic device by a cable connection or wirelessly.

8. The aircraft galley according to claim 7, wherein the controller is configured to send the work-supporting message, or an information about a current work step, or both to the electronic device; or
wherein the controller is configured to receive a user input from the electronic device; or
both.

9. The aircraft galley according to claim 1, wherein the component layer further comprises:
a scale; or
a heating element; or
a cooling element; or
any combination thereof.

10. The aircraft galley according to claim 1, wherein the countertop is configured to move between a working position in which the countertop is arranged horizontally and a display position in which the countertop is arranged vertically.

11. An aircraft, comprising:
at least one aircraft galley according to claim 1.
